(19) United States
(12) Patent Application Publication
(10) Pub. No.: US 2008/0088696 A1
(43) Pub. Date: Apr. 17, 2008

(54) Compact, portable universal script prompter and videoconferencing eye contact-assisting device for personal computers

(75) Inventor: HERNAN FELIPE GIRALDO, Dallas, TX (US)

Correspondence Address: VESNA N. RAFATY, 18926 CAMPBELL ROAD, DALLAS, TX, 75252, US

(73) Assignee: Hernan Giraldo

(21) Appl. No.: 11/838,270

(22) Filed: Aug. 14, 2007

Related U.S. Application Data
(63) Continuation of application No. 11/145,082, filed on Jun. 3, 2005.

(51) Int. Cl. H04N 7/14

(52) U.S. Cl. 348/14.08; 348/E07.083

(57) ABSTRACT

A portable, universal script prompter and videoconferencing eye contact-assisting device for personal computers for mounting on a personal computer monitor and covering an insubstantial portion of the surface of the monitor comprising a housing comprising a front face with an opening, two sides, a mirror attached to the inside of the housing and disposed at an angle to the face of the display monitor the mirror reflecting an image on the monitor, a beamsplitter disposed inside the housing above the mirror and substantially parallel to the mirror for reflecting the image reflected by the mirror, the beamsplitter visible through the opening in the front face, and a back portion disposed in the housing behind the beamsplitter for encloseably housing a webcam, the webcam lens disposed inside the back portion.

This non-provisional patent application is a Continuation Application/Divisional Application claiming priority to and incorporating by reference non-provisional patent application Ser. No. 11/145,082 filed Jun. 3, 2005 with the same inventorship.

### BACKGROUND OF THE INVENTION

The disclosed invention is generally directed to teleprompter devices (i.e., hardware, not software for teleprompting applications) for use with personal computers and specifically to portable script prompters/eye contact-assisting tools specially designed for use with webcams at all types of personal computer user stations during desktop-based recording of audiovisual presentations and/or desktop-based videoconferencing.

Via a non-patent literature search using Dialog, the applicant has located a device called See Eye2Eye™ (trademark of Bodelin Technologies) (see Information Disclosure Document) which appears to be primarily directed to promoting eye contact during video teleconferencing using webcams although it may be suitable for script prompting using webcams. Based on information available to the applicant, the applicant does not deem See Eye2Eye to be prior art. Note that See Eye2Eye employs a modified periscope design such as that employed by the applicant's device as discussed below. The applicant is not aware of prior art directed to portable, integral, compact script prompters for personal computer-based prompting and video teleconferencing applications with webcams. The term ‘compact’ as used in this document refers to a design which allows the disclosed device to be storable/portable inside a standard personal computer carrying case as a personal computer accessory without causing unsightly distortion of the case. Prior art directed to enhancing eye contact during video teleconferencing has been found and is discussed below because it is relevant to the disclosed invention although not directly on point. Prior art devices discussed below for use with image displays have disadvantages because they comprise mechanical components requiring specific installation, set-up, and adjustment, vary in bulk, weight, and degree of portability, in use cover a substantial portion of the display monitor of a personal computer, vary in cost of manufacture, and are not designed for universal use with all types of PC monitors (laptops, CRT, flat panel (LCD, plasma).

The use of beamsplitters defined herein as “partially silverized mirrors”) for promoting eye contact in desktop-computer based video teleconferencing is known. A beamsplitter consisting of a partially silvered mirror placed at roughly a 45-degree angle in front of a display permits a user to observe the image of the display reflected in the beamsplitter while a camera disposed relative to the display and the beamsplitter captures the image of the user as reflected in the beamsplitter. Among the drawbacks of such designs is their bulk due to the protrusion of the beamsplitter from the display and the lack of interoperability with all types of PC screens available on the market today.

U.S. Pat. No. 5,619,254 to McNelley entitled “Compact teleconferencing eye contact terminal” is directed to a teleconferencing terminal comprising a housing enclosing an image display means, a front-mounted beamsplitter attached to the housing where an integral portion of the beamsplitter is angled in relation to the image display means and is seamlessly suspended in front of the viewing surface of the display. The angled portion is the portion required to reflect the image of the remote conferee in the display and comprises less than the entire viewing area of the display. The user gazes through the beamsplitter at the image of the remote conferee on the display. Thus, the McNelley device is not portable, is directed to videoconferencing and not script prompting, and is not designed for use with all types of image displays.

U.S. Pat. No. 2,711,667 to Simjian is directed to a prompting device for a user to view graphic information while looking at an image forming lens (i.e., camera) which creates simultaneous virtual images of the user and graphic information visible in the line of sight of the person and the camera. The deice comprises a first transparent reflecting screen disposed between a camera lens and a user, graphic information disposed out of the camera axis but within range of first reflecting screen, a light absorbing surface, and a second transparent reflecting screen. Thus the Simjian device does not have an integral design and is not readily portable.

U.S. Pat. No. 5,666,153 to Copeland entitled “Retractable teleconferencing apparatus” is directed to a retractable optical assembly for video teleconferencing comprising a beamsplitter mounted to a video monitor positionable between an in-teleconferencing use position and a idle (i.e., for storage or non-teleconferencing use) orientation. The purpose of the beamsplitter is to reflect to the camera the image of the user while allowing the user to look directly at the image of the remote teleconferee. The beamsplitter is preferred to cover the entire visible display to help ensure a uniform image to the user. The patent also discloses an opaque panel attached to the lower portion of the beamsplitter. The preferred assembly has a camera axis perpendicular to the optic axis of the display and at a 45-degree angle to the beamsplitter.

U.S. Pat. No. 5,666,153 cites as prior art an apparatus by Tekskil Industries, Inc. with a tradename of EyeLine which utilizes a frame comprising a beamsplitter covering the face of a video display and mounted at a 45-degree angle to the video display and a secondary mirror mounted inside the frame parallel to the beamsplitter for reflecting the image reflected by the beamsplitter onto a video camera. The user looks directly at the video monitor at the image of the other conferee. Set-up of the Eyeline device requires several steps as follows: frame mounting to the monitor, camera mounting to the monitor, and adjustments of the elements of the device to maintain relative alignment. Based on the limited disclosure, it appears that the EyeLine device is not portable and is directed to eye-focusing during video teleconferencing and not script prompting.

U.S. Pat. No. 6,280,039 to Barber entitled “Script prompt device” is directed to a script prompt device for attachment to a camera lens comprising a mirror, a hood mounted to the mirror for defining a chamber and a script tray member attached to the mirror and adjustable to an open and closed position. The mirror reflects text located in or on the tray member to the user who views the text through the camera lens. The Barber patent is directed to script prompting in non-studio settings and does not disclose script as an electronic document displayed on a personal computer monitor.

U.S. Pat. No. 6,104,424 to McNelley entitled “° Foldable eye contact components for a dual mode display” is directed to a non-retracting, dual position eye contact apparatus for video teleconferencing for mounting to a display monitor comprising a housing containing the display monitor, a transparent-reflective panel attached to the housing creating in a first position a reflection of the conferee for capturing by a camera while the conferee views the display through the transparent-reflective panel. The McNelley device is bulky, not portable, and is not designed “one fits all” for universal use with all types of display monitors.

In summary, the applicant is not aware of prior art directed to a relatively inexpensive, portable, lightweight, compact, stand-alone, script prompter/videoconferencing assist device for webcams requiring minimal set-up time and specially adapted for use with all types of image display devices (CRT, flat screen (ICD, plasma) at a personal computer user station during talking-head range recording) of audiovisual presentations and/or PC-based videoconferencing.

### SUMMARY OF THE INVENTION

With the advent of the webcam, webcasting and YouTube™, the applicant recognizes there will be demand for cost effective, time efficient tools for desktop-based recording using a webcam that are simple to use and which promote quality audiovisual presentations straight from the user's PC-station (whether laptop or desktop) thereby avoiding the costs of a remote production studio. Script prompting is helpful to achieve a quality audiovisual presentation utilizing a webcam at a personal computer station. The applicant's key design parameters are affordability, compactness, portability, ease of use, universality of use with all types of commercially-available computer display devices, and integration with webcams. The applicant has invented an extremely compact, portable, integral, relatively inexpensive, lightweight, easy-to-use script prompter/eye contact-assisting tool for use with all types of personal computers (desktop, laptop) during PC-based recording of an audiovisual presentation using a webcam and/or videoconferencing using a webcam. The applicant's device does not require any modification of personal computer monitors. The preferred embodiments of the disclosed device fit inside a standard computer carrying case. Because of its low bulk, the disclosed device takes up minimal shelf space at warehouses, in shipping trucks, and at PC user stations. Because of its compactness and small size, the device covers a small portion of the front display surface of the monitor such that a user is minimally distracted when the device is placed on the monitor in position for use even when the device is not in use. The disclosed device also functions as an eye contact-assisting apparatus for enhanced experience in video teleconferencing applications at a desktop using a webcam. The preferred embodiment of the disclosed device has a dual functionality as both a computer teleprompter and enhanced webcam because it is configured with a webcam lens attached to the inside of the housing of the disclosed device.

The preferred embodiment of the disclosed device comprising a mirror and a beamsplitter comprises a portable housing with integrated elements and functions essentially like a modified periscope. A substantially flat mirror (or as used interchangeably herein, simply mirror or ‘transparent member’) and a substantially parallel beamsplitter (i.e., partially silverized mirror) disposed above the mirror and in front of a webcam disposed in the housing cooperate to project an image of a portion of the monitor display screen (showing content or as used in the video production industry ‘script,’ to be prompted, content which is out of the optic axis of the webcam lens) in the optic axis of the webcam lens and the user optic axis at the personal computer station. The disclosed device has minimal or no installation and set-up because of its integrated design where key components (mirror, beamsplitter, ambient light/contrast shields (effectively referring to the ‘sides’ of the housing comprising the device) are integral to the device. The integrated design ensures proper alignment of the components (mirror, beamsplitter, webcam lens) without the need for separate installation and/or adjustment steps. Thus, per one embodiment of the disclosed device designed to be compatible with commercially-existing webcams sold as separate computer accessories, the user manually places the disclosed device on the top edge of the personal computer monitor over the webcam (typically mounted on the top edge of the monitor), plugs the webcam into the USB port of the personal computer, and is ready to start recording audiovisual presentations and/or engage videoconferencing. The script prompter helps promote a professional audiovisual recording because it helps keep the user's eyes directly on the lens of the webcam while the user reads a prepared script that represents lines of an electronic document displayed on the computer monitor.

The preferred embodiment of the disclosed device for script prompting applications is designed to allow a user seated at a desktop station to comfortably see a reflected image of four to six lines of script at a font size of 16 in the optic axis of the webcam. That design objective means that the device covers an insubstantial portion of the front face of the display. The width of the beamsplitter and the mirror essentially determine the depth (i.e., the width of the sides) of the device. A design (objective for the preferred embodiment is to minimize the size of mirror required for reflecting an acceptable number of lines of content to promote user control and comfort in the recording of the audiovisual presentation. Per a so-called First Preferred Embodiment (so called because it was described in the referenced parent application) of the disclosed device, the mirror and the beamsplitter have roughly the following dimensions (L×W); 1-inch by 2.5 inches, with an aspect ratio of 176 pixels by 144 pixels, providing for an extremely compact device with a minimal protrusion from the face of the monitor and the mirror and the beamsplitter have a separation distance of approximately 1-inch. The applicant has also developed prototypes wherein the beamsplitter is slightly wider than the mirror for a more enhanced user experience with script prompting. Per an alternative so-called Second Preferred Embodiment of the disclosed device comprising a mirror and a beamsplitter, specially adapted for both videoconferencing and script prompting, the mirror and beamsplitter dimensions are roughly 1⅜″×2 and have an aspect ratio of 320 pixels by 240 pixels.

The disclosed device is extremely compact and covers a minimal portion of the surface of the monitor thus enabling the user to transition readily to other computer input tasks and tasks unrelated to audiovisual recording and/or videoconferencing even while the device rests on the monitor. Additionally, per a special “flip-back feature” of the Second Preferred Embodiment described below, the housing with the mirror and beamsplitter rotates back away from the display screen of the monitor while the device rests independently on the top edge of the monitor with the webcam housed in its chamber.

The beamsplitter per the disclosed preferred embodiments has been optimized to promote a quality reflected image with a standard webcam such that its transmission to reflection ratio is approximately 75/25 or 70/30. Other transmission-to-reflection ratios are possible and will achieve acceptable quality of reflected image. The disclosed device has design features which help to minimize the amount of ambient light inside the device thereby helping to prevent degradation of the reflected image. Thus, for example, the preferred embodiment of the disclosed device comprises a housing with two sides, opaque internal surfaces, a portion for enclosing a webcam, and an opening in the front face of the housing sized to expose substantially only the beamsplitter.

The disclosed device has a universal use and is adapted to be mountable on any kind of personal computer monitor, whether flat panel display (LCD, plasma), CRT, or laptop.

Per an alternative embodiment, the disclosed device incorporates a magnifying lens, such as a Fresnel lens or a customized lens with optimized concavity and convexity, attached to the inside of the housing and disposed between the mirror and the beamsplitter for capturing more content without the need to increase the size of the device (i.e., no need to significantly increase the size of the mirror and beamsplitter). Thus, the embodiment with the magnifying lens is especially suited for videoconferencing because it presents to the user a larger image of the remote conferee (i.e., an image closer to approximating the size of the video image currently available with standard webcam applications) than is possible with the embodiment of the disclosed device without a magnifying lens.

Alternatively, a specially-designed magnifying lens is substituted for the lower mirror.

The housing of the disclosed device has a coating on its edges which contact the face of the computer monitor to help prevent scratching of the surface of the display monitor.

The preferred embodiment of the disclosed device has an opaque front face having an opening optimally sized to allow the user to view all of the content reflected by the beamsplitter without exposing to the user a view of the mirror located below the beamsplitter. The purpose of the front face is to help to minimize the amount of ambient light entering the inside of the housing of the computer prompter so as to enhance the quality of the image and user experience. The front face also helps to minimize optic distraction to the user that could occur if more of the inside of the housing were exposed to the user's view. It is noted that alternative designs are possible which eliminate the front face, vary or reduce the size of the front space, or which provide for a non-opaque or a partially opaque front face. Such alternative designs are considered to be within the scope of the claimed invention.

The purpose of the sides of the housing is to shield some ambient light away from the inside surfaces of the housing so as to minimize degradation of the image reflected by the mirror and the beamsplitter. The size (depth) of the sides is generally determined by the size of the mirror and beamsplitter.

As described, the disclosed script prompter device is also suitable for use as an eye contact-assisting apparatus to help ensure more natural conferencing at personal computer stations using webcams. The webcam lens captures the user looking at the beamsplitter reflecting an image of the remote conferee by the mirror below the beamsplitter. The user places the device in the area of the monitor displaying the image of the remote conferee. Alternatively, the user moves (drags) the image of the remote conferee with a mouse to the portion of the monitor over which the device is placed. An embodiment as described above which incorporates a magnification lens such as a Fresnel Lens or a customized lens helps enhance the user experience during teleconferencing by presenting to the user a larger image of the remote conferee without the need to increase the size of the disclosed script prompter.

The disclosed device is designed to be mountable on a edge of the computer monitor. The preferred embodiment has a top portion specially adapted to allow the device to rest stably, adjustably, and independently on the top edge of the monitor without a separate monitor attachment or monitor securement means. Alternative means of mounting which are considered to be within the scope of this disclosure include but are not limited to the following: monitor clip, rollers, clamps, and/or a latch hinge or other design allowing for rotation of the device or a portion (the housing) of the device away from the surface of the monitor when the device is not in use.

The applicant has also developed an embodiment that has a beamsplitter and is free of the lower mirror as per the above-described preferred embodiments featuring both a mirror and a beamsplitter. As per the applicants invention, the beamsplitter-only embodiment is also compact, freely mountable on the top edge of a computer monitor, does not require modification of the monitor, does not require assembly, or adjustment of its integral component elements (webcam, beamsplitter), and covers an insubstantial portion of the display screen of the monitor. The beamsplitter is attached to a housing and is angled at roughly 45 degrees to the horizontal. The webcam is housed inside a rear portion of the housing and is directed downward at the beamsplitter to capture an image of the user as reflected in the beamsplitter as the user views an image for prompting through the beamsplitter.

Finally, the applicant has developed a relatively simple, mirror-free and beamsplitter-free embodiment of the disclosed device especially suited for script prompting using a personal computer and a webcam. That embodiment, also designed for adjustable mounting on the top edge (or possibly a side edge) of the personal computer monitor, comprises a substantially flat front face comprising an opaque portion and an integral lower transparent portion allowing direct viewing of the image on the display screen behind the transparent portion. The webcam lens, its optic axis directed at the user optic axis, is situated behind the opaque portion of the front face slightly (as an illustration and not by way of limitation, approximately one-half inch) above the top edge of the transparent portion. The slight offset placement of the webcam lens relative the transparent portion has been found empirically to be sufficient to allow the user to simultaneously read the script while appearing to be looking at the webcam. The purpose of the opaque portion is to hide the webcam and to help direct the user's eyes to the transparent portion where the script (text) for prompting is to be found. Using a user input device, the user moves text for prompting into the area behind the transparent portion of the front face of the device.

### DRAWINGS

FIG. 1 is a front perspective of a so-called First Preferred Embodiment of the disclosed device comprising a mirror and a beamsplitter.

FIG. 2 shows an exploded rear perspective of the First Preferred Embodiment of the disclosed device;

FIG. 3 shows a version of the First Preferred Embodiment suitable for use in combination with existing commercially-available webcams;

FIG. 4 shows an exploded view of component parts for a Second Preferred Embodiment of the disclosed device comprising a mirror and a beamsplitter

FIG. 5 shows the Second Preferred Embodiment mounted on the personal computer monitor with the mirror and beamsplitter flipped back away from the monitor;

FIG. shows the Second Preferred Embodiment mounted on the top edge of a personal computer monitor with the webcam optic cone noted;

FIG. 7 shows an alternative embodiment comprising a beamsplitter and no mirror;

FIG. 8 shows an alternative mirror-free and beamsplitter-free embodiment of the disclosed device;

FIG. 9 shows a side view of the mirror-free and beamsplitter-free embodiment of the disclosed device;

FIG. 10 shows mock-ups of the First Preferred Embodiment and the Second Preferred Embodiment and highlights various aspect ratios for the mirror and beamsplitter how they affect depth of the device.

### DESCRIPTION OF THE DRAWINGS

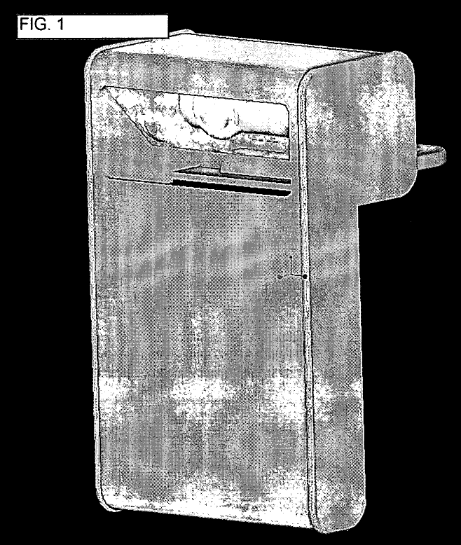

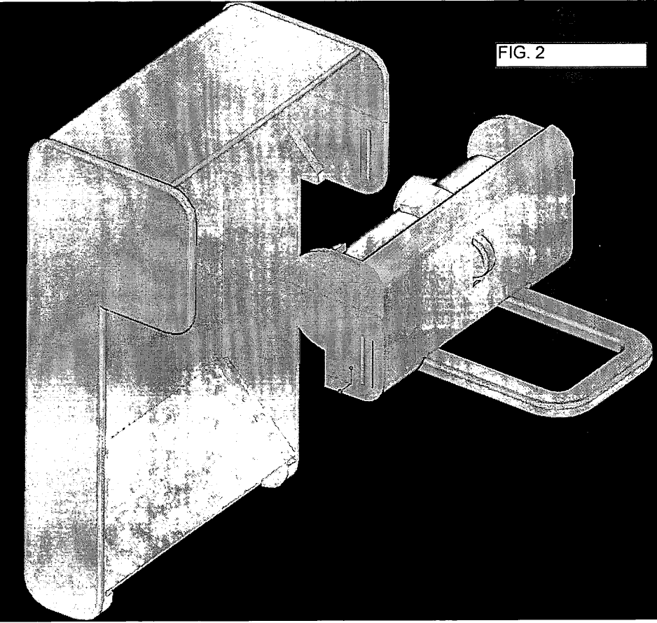

FIG. 1 is a front perspective of the First Preferred Embodiment of the disclosed device exposing a housing comprising a front face, an opening in the front face exposing a beamsplitter, a webcam lens disposed behind the beamsplitter, and showing one exposed side.

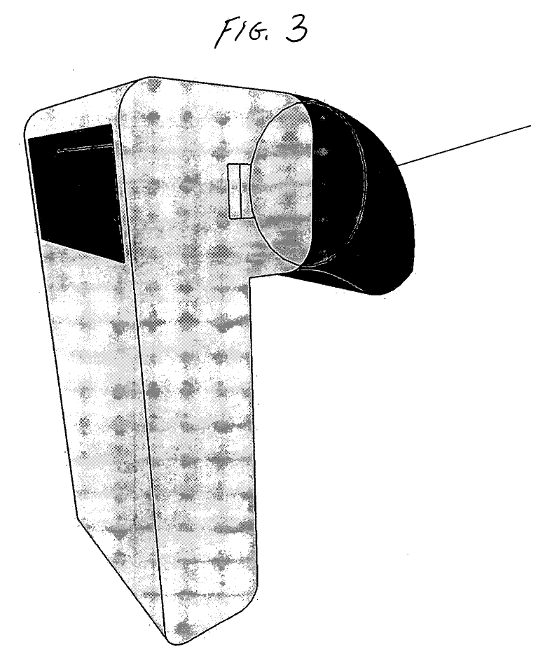

FIG. 2 is a side perspective of the so-called First Preferred Embodiment of the disclosed device exposing a mirror, a beamsplitter above the mirror inside the housing, a rear portion containing a webcam and attachable to the housing behind the beamsplitter, and a monitor clip to assist with securement of the device to the top edge of the personal computer monitor.

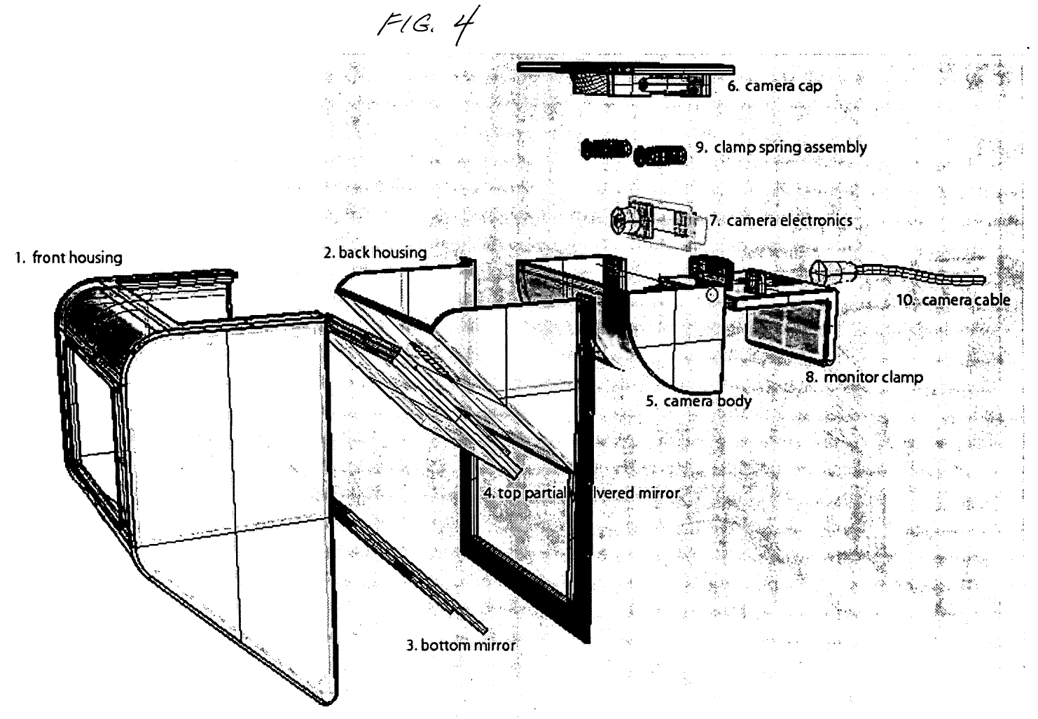

FIG. 3 shows a version of the First Preferred Embodiment adapted for use in combination with existing commercially-available webcams. Thus, per FIG. 3, the rear portion of the device comprises a rigid shroud portion for covering and enclosing a commercially-available webcam mounted on the top edge of the computer monitor.

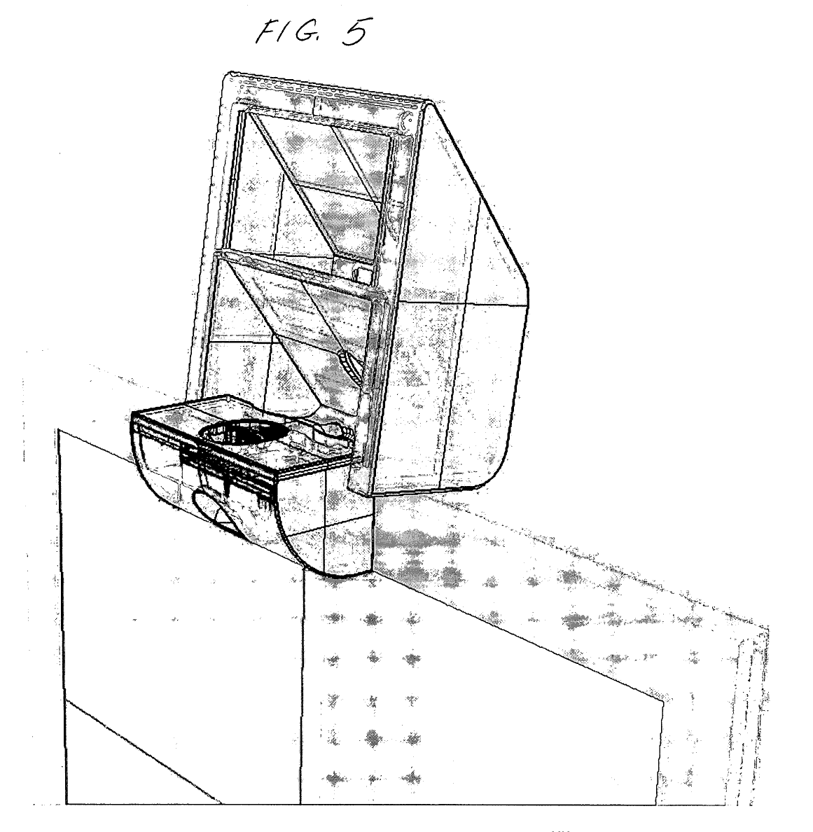

FIG. 4 shows an exploded view of the Second Preferred Embodiment of the disclosed device. Figure shows components of the so-called Second Preferred Embodiment of the disclosed device as follows: a front housing 1 having an opening, a bottom mirror 3 for attachment to the inside of the front housing 1, a beamsplitter (partially silvered mirror) 4 attached to a back housing 1 for attachment to the inside of the front housing 1, a so-called camera body 5 defining a chamber for housing the webcam 7, a monitor clamp 8 for securing the device to the display monitor of a personal computer, and a camera cap 6 which serves as a top portion for the device for enclosing the webcam 7. It is noted that the Second Preferred Embodiment comprises a front housing and a back housing. The two-housing design is not essential and could be substituted with a single-housing design. However, the two-housing design offers added stability to the device.

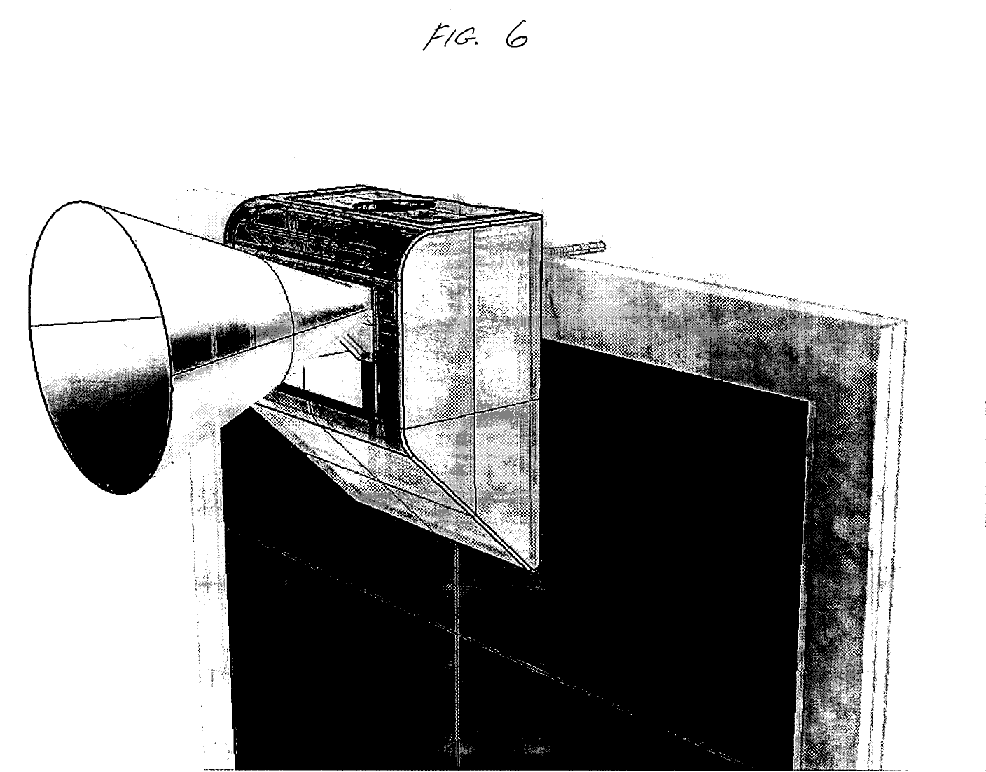

FIG. 5 shows the flip-back feature of the Second Preferred Embodiment whereby the front and back housing comprising the mirror and beamsplitter are manually caused to rotate back away from the front surface of the personal computer monitor exposing the camera body portion housing the webcam.

FIG. 6 shows the Second Preferred Embodiment mounted on the top edge of the personal computer monitor and depicts the optic (sight) cone of the webcam embedded inside the device.

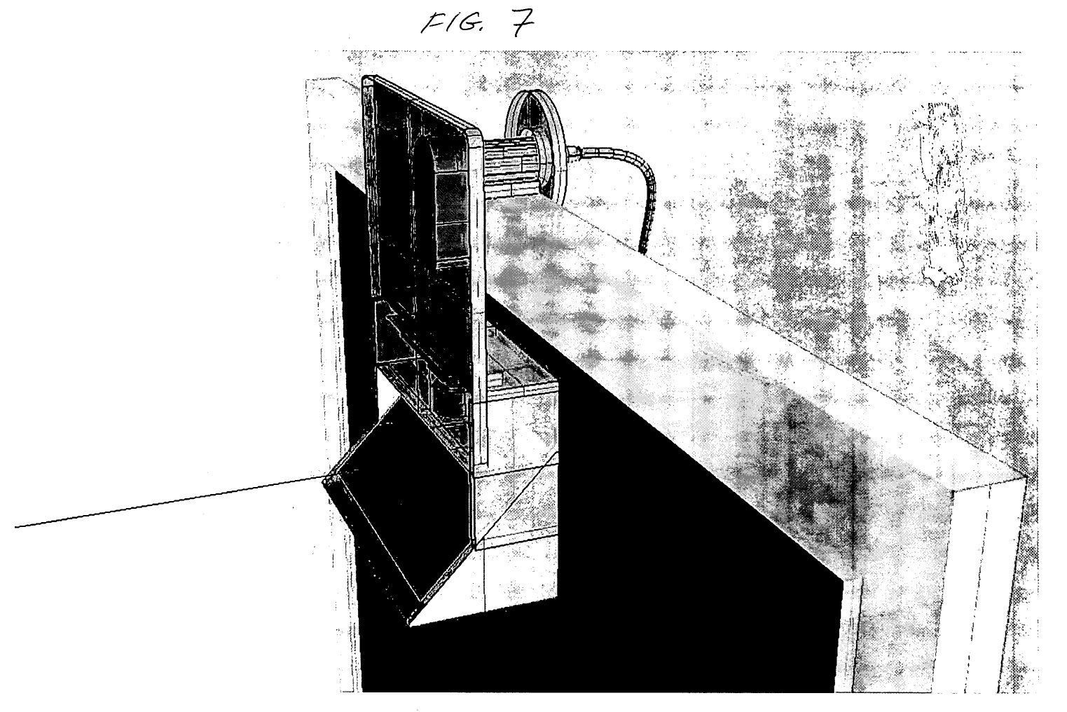

FIG. 7 shows a beamsplitter-only version of the disclosed device mounted on the top edge of a personal computer monitor. Visible is the beamsplitter disposed inside the housing at an angle to the monitor. The webcam (not visible) is housed inside the rear portion of the housing.

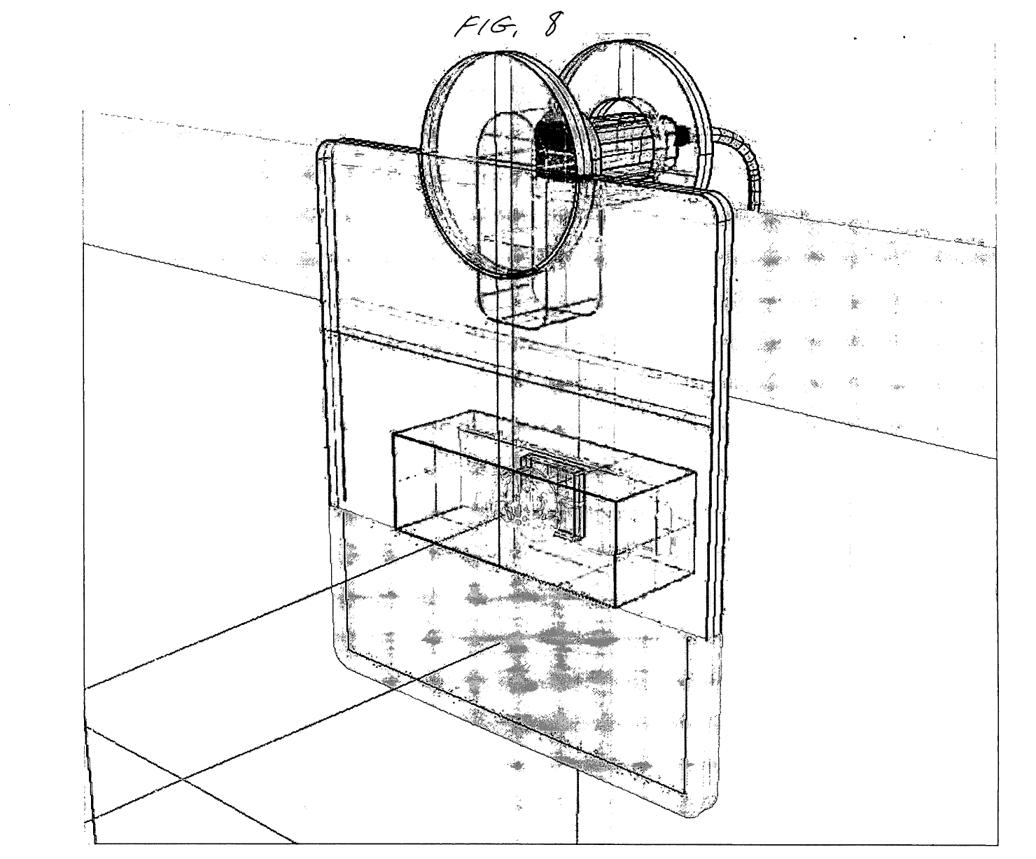

FIG. 8 shows a mirror-free and beamsplitter-free version of the disclosed device comprising a flat front face with an opaque upper portion and a transparent lower portion with the webcam lens disposed behind the upper opaque portion a minimal distance above the boundary line between the upper opaque portion and the lower transparent portion.

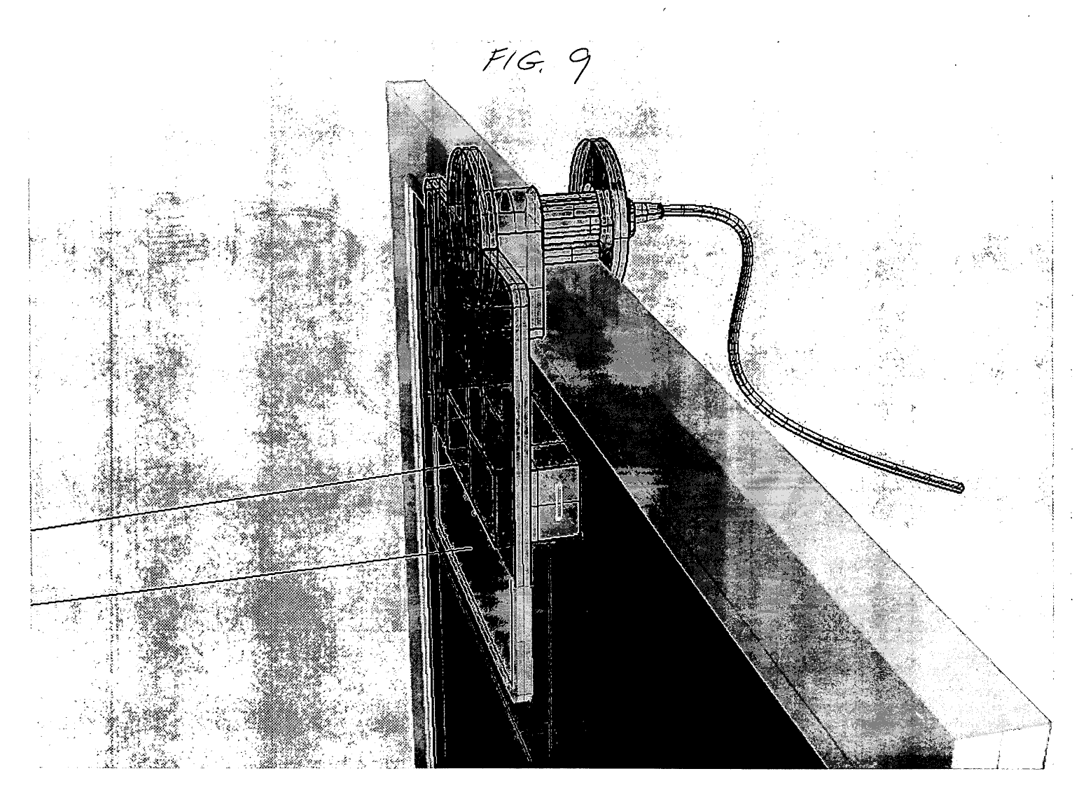

FIG. 9 shows a side view of the mirror-free and beamsplitter-free version of the disclosed device mounted on the top edge of a personal computer monitor. The side view exposes a view of the compartment housing the webcam lens.

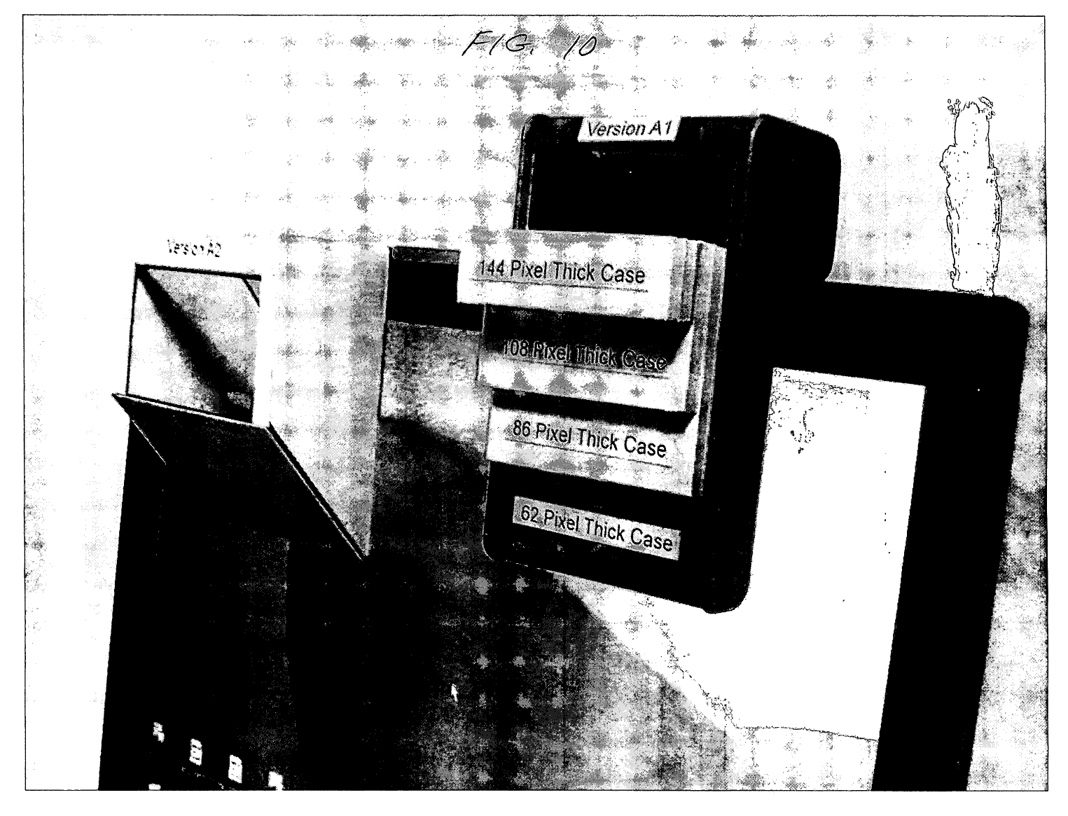

FIG. 10 shows mockups of a First Preferred Embodiment and the Second Preferred Embodiment mounted on the top edge of a computer monitor. The figure shows how the aspect ratio of the mirror and beamsplitter determine the thickness (depth of the sides) of the housing of the device.

I claim:

1. A portable script prompting and videoconferencing eye contact-assisting device for use with a personal computer, the device adapted for adjustable mounting on the top edge of the display monitor of the personal computer and covering an insubstantial portion of the front surface of the display monitor, the device comprising a housing, the housing comprising two sides and a front face, the front face comprising an opening, a back portion in contact with the housing defining a chamber for encloseably housing a webcam, the webcam lens adjustably disposed inside the back portion, a mirror attached to the inside of the housing at an angle relative to the plane of the face of the monitor for reflecting an image displayed on the monitor, a beamsplitter disposed inside of the hosing above the mirror and approximately parallel to the mirror and in front of the webcam lens for capturing and reflecting the image reflected by the mirror in the axis of the webcam lens and a user optic axis, the beamsplitter visible through the opening in the front face.

2. The device per claim 1 further comprising a means for rotatably moving the mirror and beamsplitter away from the front surface of the display monitor while the back portion defining a chamber for enclosing the webcam rests on the top edge of the monitor to allow use of the webcam without prompting.

3. The device per claim 1 wherein the device is sized to be storable as an accessory inside a personal computer carrying case.

4. The device per claim 1 further comprising a magnifying lens disposed inside of the housing between the mirror and the beamsplitter for magnifying the image reflected by the mirror.

5. The device per claim 1 wherein the mirror is a magnifying lens.

6. The device per claim 1 wherein the back portion defining a chamber for encloseably housing a webcam comprises a flexible opaque material.

7. The device per claim 1 wherein the back portion defining a chamber for encloseably housing a webcam comprises a rigid cover.

8. The device per claim 1 wherein the beamsplitter has a transmission-to-reflection ratio of 75/25.

9. The device per claim 1 wherein the beamsplitter has a transmission-to-reflection ratio of 70/30.

10. The device per claim 1 wherein the aspect ratio of the mirror and the beamsplitter is 320 pixels by 240 pixels.

11. A portable script prompting and videoconferencing eye contact-assisting device for a personal computer, the device adapted for adjustable mounting on the top edge of the display monitor of the personal computer and covering an insubstantial portion of the front surface of the display monitor comprising a housing comprising a front face with an opening, two sides, and a rear portion comprising a closed chamber with a webcam lens housed therein, a beamsplitter attached to the inside of the housing at an angle to the plane of the face of the personal computer monitor for reflecting an image on the display monitor, the beamsplitter visible through the opening in the front face, the webcam lens capturing an image of a user reflected in the beamsplitter.

12. A portable prompting device for use with a personal computer adapted for adjustable mounting on an edge of the display monitor of the personal computer, and covering an insubstantial portion of the display monitor comprising a substantially flat front face comprising an upper non-transparent portion and a contiguous lower transparent portion a webcam lens attached to the back of the front face behind the upper portion just above a boundary line between the upper nontransparent portion and the lower transparent portion for capturing an image of a user, an image for prompting visible in the transparent portion.

13. The device per claim 12 wherein the upper nontransparent portion of the front face is opaque.
